(19) United States
(12) Patent Application Publication
(10) Pub. No.: US 2022/0398927 A1
(43) Pub. Date: Dec. 15, 2022

(54) METHOD AND APPARATUSES FOR PREVENTING SAFETY-CRITICAL TRAFFIC SITUATIONS BETWEEN VEHICLES

(71) Applicant: Continental Teves AG & Co. OHG, Nürnberg (DE)

(72) Inventors: Thomas Grotendorst, Eschborn (DE); Sebastian Strunck, Niedernhausen (DE)

(21) Appl. No.: 17/771,379

(22) PCT Filed: Oct. 22, 2020
(86) PCT No.: PCT/DE2020/200092

§ 371 Date: Apr. 22, 2022

(30) Foreign Application Priority Data
Oct. 24, 2019 (DE) 10 2019 216 380.7

(51) Int. Cl. G08G 1/16; G08G 1/0968; H04W 4/44

(52) U.S. Cl. CPC G08G 1/164; G08G 1/166; G08G 1/096811; H04W 4/44

(57) ABSTRACT

A method, wherein a received planned trajectory of a first vehicle relative to a received planned trajectory of the second vehicle is evaluated with respect to a potentially safety-critical situation and, if a potential safety-critical situation is detected, the planned trajectory of the second vehicle is output to be received by the first vehicle. Moreover, a corresponding method for execution by a communication apparatus of a first vehicle or an infrastructure device, wherein a planned trajectory of the first vehicle is output by means of a mobile radio interface of the first vehicle or the infrastructure device and by means of a communication interface designed for direct vehicle-to-X communication of the first vehicle or the infrastructure device. Furthermore, a method for preventing a potential safety-critical traffic situation between a first vehicle and a second vehicle, a processing apparatus, a communication apparatus and a system.

### BACKGROUND

The present invention relates to a method for execution by a processing apparatus, a corresponding method for execution by a communication apparatus of a first vehicle or an infrastructure device for preventing a potential safety-critical traffic situation between a first vehicle and a second vehicle, a corresponding processing apparatus, communication apparatus and system.

Current approaches to the implementation of vehicle-to-X communication are effected by means of a mobile radio network or via a direct connection between road users or road users and corresponding infrastructure devices equipped therefor, for example by means of direct vehicle-to-X communication, wherein information regarding planned routes can be transmitted in future in the form of trajectories. As a function of the respective communication technology, the mobile radio interface can be known, for example, by the term “Uu interface”, and the interfaces or technologies designed for direct communication can be known, for example, by the term “DSRX”, “IEEE 802.11p”, “direct link” or “PC5”.

With regard to local maneuver coordination, direct communication currently appears to be preferred, in particular due to the shorter latencies. From the current point of view, communication between road users, which is supported by means of a mobile radio network, in particular for maneuver coordination, has too long latencies and insufficiently secured connection quality.

However, a final coordination between road users regarding the execution of a maneuver, taking into account the range of the short-range communication and the respective general conditions such as, for example, speed and masking is not made possible in every case, which can give rise to safety-critical traffic situations.

The object of the invention is therefore to provide a means which overcomes the indicated disadvantages.

### BRIEF SUMMARY

This object is achieved by the subject-matter of the independent claims. Advantageous configurations can, for example, be inferred from the subclaims. The content of the claims refers expressly to the content of the description.

The invention describes a method for execution by a processing apparatus which is in particular external to the vehicle, having the steps of:

receiving a planned trajectory of a first vehicle, which has been output by means of a mobile radio interface of the first vehicle or an infrastructure device,

receiving a planned trajectory of a second vehicle, which has been output by means of a mobile radio interface of the second vehicle or a further infrastructure device,

evaluating the planned trajectory of the first vehicle relative to the planned trajectory of the second vehicle with respect to a potential safety-critical situation by means of a computing device of the processing apparatus and, if a potential safety-critical situation is detected,

outputting the planned trajectory of the second vehicle for the purpose of outputting by means of an outputting device suitable for communicating via a mobile radio network, to be received by the mobile radio interface of the first vehicle or the infrastructure device.

Deteriorations in sending/receiving conditions can frequently occur in the case of direct vehicle-to-X communication, in particular within towns and cities, particularly due to the many and varied shading situations, for example due to houses. Consequently, the invention is based on the idea of providing a processing apparatus external to the vehicle, in particular a so-called backend server, which evaluates planned trajectories of the vehicles received from vehicles and if a potentially safety-critical situation such as, for example, a possibly imminent collision is detected, at least one of the vehicles relating to the detected situation is provided with the planned trajectory of the respective other vehicle relating to the situation by means of a point-to-point mobile radio connection, for example LTE 4G, 5G. The possible restriction that the forwarding is solely effected in the event that a potentially safety-critical situation is detected is implemented here by a filter function for reducing the resource consumption of the respective vehicles since, in principle, no forwarding is carried out if no potentially safety-critical traffic situation is detected. Consequently, a maneuver cooperation for preventing a potential safety-critical situation in the case of restricted, direct vehicle-to-X communication is also made possible.

It is in principle provided that the first vehicle and/or the second vehicle and/or the infrastructure device or the further infrastructure device output(s) the planned trajectories in parallel by means of direct vehicle-to-X communication as well as by means of a mobile radio network. In particular, this should be understood to be a substantially simultaneous outputting of substantially consistent information by means of the various communication channels. Comparatively small temporal deviations can be produced, for example, by different processing speeds. In principle, the simultaneous outputting should be carried out by means of both communication interfaces within 1 s.

In order to receive the planned trajectories of the vehicles, the underlying processing device has one or more receiving devices suitable for this purpose. Here, the receiving device does not necessarily have to represent a mobile radio interface comprised by the processing device as such, since the signals are usually converted at least once in cellular communication systems, for example at a mobile radio mast receiving the mobile radio signals, wherein the further transfer can also be effected, by way of example, in a wired manner, up to another mobile radio mast for outputting by means of mobile radio signals or by means of the TCP/IP directly to the receiver. However, communication is effected with the vehicles at least partially by utilizing a mobile radio network.

In the event that the infrastructure device or the at least one further infrastructure device outputs the respective trajectory/trajectories by means of the respective mobile radio interface, it can be provided that the respective infrastructure device receives the respective planned trajectory from the first or second vehicle by means of direct vehicle-to-X communication and/or determines this with the aid of capturing by sensors, including in particular on the basis of a prediction of the planned route.

According to a further development, it can alternatively or additionally be provided that the planned trajectory of the first vehicle is output by the processing apparatus by means of an outputting device suitable for communicating via a mobile radio network, to be received by the second vehicle, if a potential safety-critical situation is detected.

According to a further development, a potential safety-critical situation is deemed to be detected, if the planned trajectory of the first vehicle and the trajectory of the second vehicle indicate that a limit value describing a distance between the first vehicle and the second vehicle will be fallen short of in the future, based on the same point in time. This can be deemed to be the case, in particular, if the trajectories intersect, based on a coincident point in time. In this case, there would be a risk of a collision between the first and second vehicle, that is to say, a safety-critical traffic situation.

A computing device can be any device which is designed to process data. For example, the computing device can be a processor, a digital signal processor, a Central Processing Unit (CPU), a Multi-Purpose Processor (MPP), an ASIC or similar.

A vehicle can be a motor vehicle, in particular a car, a truck, a motorcycle, an electric vehicle or a hybrid vehicle, a watercraft or an aircraft.

According to a further development, in the event that a potential safety-critical situation has been detected, the planned trajectory of the second vehicle is not output, if the processing apparatus receives information from the first vehicle and/or the second vehicle announcing that a forwarding between the first vehicle and the second vehicle by means of the processing device is no longer required. The fact that a forwarding between the first vehicle and the second vehicle by means of the processing device is no longer required can, in particular, be due to the fact that it has been detected by the first vehicle and/or the second vehicle that a direct vehicle-to-X communication is henceforth possible. Information announcing that a forwarding is no longer required can be implemented, for example, by means of a, in particular, dedicated message and/or an exclusion list relating to the communication link between the first vehicle and second vehicle. Furthermore, information announcing that a forwarding is required again can be provided, which can become important, by way of example, if a direct vehicle-to-X communication which was initially made possible is prevented again and a potential safety-critical situation has previously been detected.

In accordance with an embodiment, the method furthermore has the step of:

receiving environmental information, captured by sensors, of the first vehicle or the infrastructure device, which has been output by means of the mobile radio interface of the first vehicle or the infrastructure device.

Consequently, in order to detect potential safety-critical situations, road users or objects captured by sensors can also be taken into account, wherein in this case at least their position and/or, if applicable, predicted trajectories derived with the aid of the environmental information can be utilized as planned trajectories for determining whether a potential safety-critical situation exists. In the case of the infrastructure device, this embodiment has already been described for capturing the trajectory of the first vehicle.

In accordance with an embodiment of the method for execution by a processing apparatus, a proposed trajectory and an alternative trajectory of the first vehicle as well as a proposed trajectory and an alternative trajectory of the second vehicle are received by the processing apparatus, wherein the proposed trajectory of the first vehicle relative to the proposed trajectory of the second vehicle is evaluated with respect to potential safety-critical situations by means of the computing device of the processing apparatus.

According to the invention, the proposed trajectory or alternative trajectory represent planned trajectories, wherein a proposed trajectory reproduces a planned trajectory which the first vehicle intends to drive from the current point of view and an alternative trajectory from the current point of view describes a likewise possible drivable route, but which does not represent the preferred choice. Taking into account the route to be driven and further general conditions, a proposed trajectory can, for example, require the lowest possible energy outlay, wherein an alternative trajectory can require a higher energy outlay but, for further considerations, by way of example of a planned trajectory of another road user, may ultimately be preferred to the proposed trajectory.

According to a further development, it can be provided that in the event that a potential safety-critical situation of the proposed trajectory of the first vehicle relative to the proposed trajectory of the second vehicle is detected, the proposed trajectory of the first vehicle relative to the alternative trajectory of the second vehicle and/or the alternative trajectory of the first vehicle relative to the proposed trajectory of the second vehicle and/or the alternative trajectory of the first vehicle relative to the alternative trajectory of the second vehicle with respect to potential safety-critical situations is/are evaluated by means of a computing device of the processing apparatus. If the aforementioned evaluations determine at least one constellation for which there is no potential safety-critical situation, provision can be made, according to a further development, during the outputting of the planned trajectory of the second vehicle for the purpose of outputting by means of an outputting device suitable for communication via a mobile radio network and to be received by the first vehicle, to output the planned trajectory of the second vehicle, for which no potential safety-critical situation has been detected, or to add information regarding for which of the constellations or trajectories relative to the planned trajectory/trajectories of the first vehicle no safety-critical situation has been detected. Moreover, provision should be made for this embodiment that the second vehicle is informed of the result so that the respective conflict-free trajectory is driven. Likewise, in this case, it seems to be necessary to provide confirmation to the processing device or the first vehicle that this is being effected. In the case of the embodiments which have been described in this paragraph, the processing apparatus has a greater influence with respect to processing and control possibilities for assessing and selecting or suggesting the trajectories. These functionalities can also be implemented by way of the processing apparatus by respective computing units of the vehicles.

In accordance with an embodiment, the processing apparatus selects the received information with respect to its relevance for a maneuver coordination.

The processing apparatus expediently saves the received planned trajectories in a data memory at least temporarily.

Furthermore, the invention relates to a method for execution by a communication apparatus of a first vehicle or an infrastructure device, having the steps of:

outputting a planned trajectory of the first vehicle by means of a mobile radio interface of the first vehicle or the infrastructure device to be received by a processing apparatus, as well as

outputting the planned trajectory by means of a communication interface designed for direct vehicle-to-X communication of the first vehicle and/or the infrastructure device, to be received by a second vehicle.

Accordingly, it can be provided, according to an embodiment, that the planned trajectory of the second vehicle is output by means of a mobile radio interface of the second vehicle or a further infrastructure device and, furthermore, by means of a communication interface of the second vehicle and/or the further infrastructure device which is designed for direct vehicle-to-X communication.

As already described, it can be provided that in the event that the infrastructure device or the at least one further infrastructure device outputs the respective trajectory/trajectories by means of the respective mobile radio interface, the respective infrastructure device receives the respective planned trajectory from the first or second vehicle by means of direct vehicle-to-X communication and/or determines this with the aid of capturing by sensors, including in particular on the basis of a prediction of the planned route.

The direct vehicle-to-X communication, by way of example using IEEE 802.11p, IEEE 1609.4, DSRC, ITS-G5 or 5G PC5 or direct link, is usually more restricted in its range compared to communication by means of a mobile radio network, which can be further intensified by shading, as already described. Accordingly, it is provided that the first vehicle and/or the second vehicle and/or the infrastructure device or the further infrastructure device output(s) the planned trajectories in parallel by means of direct vehicle-to-X communication as well as by means of a mobile radio network. In particular, this is understood to be substantially simultaneous outputting of substantially consistent information by means of the various communication channels. Comparatively small temporal deviations can be produced, for example, by different processing speeds. For example, provision can accordingly be made for the simultaneous outputting to be carried out by means of both communication interfaces within 1 s. The processing by the processing device of the trajectories output by means of mobile radio has already been described.

In accordance with an embodiment of the method for execution by a communication apparatus of a first vehicle or the infrastructure device, the method furthermore has the steps of:

receiving a planned trajectory of a second vehicle by the processing device (A.2) using the mobile radio interface,

transmitting the planned trajectory of the second vehicle to a maneuver planning device of the first vehicle in order to determine and initiate measures for overcoming the potential safety-critical traffic situation.

If a planned trajectory of the second vehicle is received by the first vehicle or the infrastructure device from the processing device by means of the mobile radio interface, a potentially safety-critical situation exists, in accordance with one embodiment, since otherwise it would not have been output by the processing device. The transmission to the maneuver planning device makes it possible for appropriate measures to be prepared or carried out promptly such as, for example, selecting an alternative trajectory or planning a changed trajectory or outputting signals to implement a direct intervention in the vehicle dynamics of the first vehicle. In order to implement the measures, the maneuver planning device is suitably connected to corresponding vehicle systems for implementing the maneuvers in order to transfer data. More complex maneuver planning operations involving the second vehicle can also be provided. This is effected in particular as a function of whether the direct vehicle-to-X communication with the second vehicle could be made possible at the respective point in time. If the planned trajectory of the second vehicle is received by the infrastructure device, the latter is designed to output the planned trajectory of the second vehicle by means of the communication interface for direct vehicle-to-X communication, to be received by the first vehicle, and, correspondingly, to the maneuver planning device of the first vehicle.

According to a further development, the method for execution by a communication apparatus of a first vehicle or the infrastructure device furthermore has the steps of:

receiving a directly transmitted vehicle-to-X message from the second vehicle,

outputting, by means of the mobile radio interface, to be received by the processing apparatus, information announcing that a forwarding between the first vehicle and the second vehicle or the infrastructure device and the second vehicle by the processing device is no longer required.

In accordance with an embodiment, the method for execution by a communication apparatus of a first vehicle or an infrastructure device furthermore has the steps of:

outputting environmental information, captured by sensors, of the first vehicle or the infrastructure device by means of the mobile radio interface of the first vehicle or the infrastructure device to be received by a processing apparatus, as well as

outputting the environmental information, captured by sensors, by means of the communication interface designed for direct vehicle-to-X communication of the first vehicle or the infrastructure device.

In accordance with an embodiment of the method for execution by a communication apparatus of the first vehicle or the infrastructure apparatus, a collective perception message comprises the environmental information output by means of the communication interface designed for direct vehicle-to-X communication of the first vehicle or the infrastructure device. The information content of “collective perception messages” (CPM according to ETSI) can advantageously be utilized for dispatching captured environmental information or object information, which has been captured by sensors, by means of the mobile radio interface to the processing device. Consequently, road users or objects, which do not independently provide their ego position or trajectory by means of a mobile radio interface or vehicle-to-X communication, which have not (initially) been captured by means of direct vehicle-to-X communication, can also be taken account of in order to detect potential safety-critical situations. Alternatively, a multi-hop mechanism via vehicle-to-X communication could also be considered, but this does not ensure that the desired recipient also receives said message content. At ETSI, work is currently being carried out on standardizing the collective perception message (TR 103562 and TS 103324), which can comprise information regarding a plurality of detected objects. The CPM combines many detected objects in one message.

In accordance with an embodiment of the method for execution by a computing device of a first vehicle, at least one planned trajectory and at least one alternative trajectory are in each case output as planned trajectories by means of the mobile radio interface of the first vehicle or the infrastructure device as well as by means of the communication interface designed for direct vehicle-to-X communication of the first vehicle or the infrastructure device. The outputting is effected via the various interfaces, as already described, in parallel or substantially simultaneously.

The invention further relates to a method for preventing a potential safety-critical traffic situation between a first vehicle and a second vehicle, having the steps of:

outputting a planned trajectory of the first vehicle by means of a mobile radio interface of the first vehicle or an infrastructure device to be received by a processing apparatus as well as outputting the planned trajectory by means of a communication interface of the first vehicle or the infrastructure device, which is designed for direct vehicle-to-X communication,

receiving the planned trajectory of the first vehicle by the processing apparatus,

evaluating the planned trajectory of the first vehicle relative to a received planned trajectory of the second vehicle with respect to a potential safety-critical situation by means of a computing device of the processing apparatus and, if a potential safety-critical situation is detected,

outputting the planned trajectory of the second vehicle to be received by the first vehicle or the infrastructure device by means of an outputting device suitable for communicating via a mobile radio network,

receiving the planned trajectory of the second vehicle by means of the mobile radio interface of the first vehicle or the infrastructure device, and

transmitting the planned trajectory of the second vehicle to a maneuver planning device of the first vehicle in order to determine and initiate measures for overcoming the potential safety-critical traffic situation.

According to a further development, the planned trajectory of the second vehicle has been output in a comparable manner to the procedure already described relative to the first vehicle by means of a mobile radio interface of the second vehicle or a further infrastructure device as well as by means of a communication interface of the second vehicle or the further infrastructure device, which is designed for direct vehicle-to-X communication. In particular, the planned trajectory of the second vehicle has been received in a corresponding manner by the processing apparatus. The transmission of the planned trajectory of the second vehicle to a maneuver planning device of the first vehicle can be carried out, in accordance with an embodiment, in which the planned trajectory of the second vehicle is initially received by the infrastructure device, by the infrastructure device by means of direct vehicle-to-X communication to a communication apparatus of the first vehicle.

The invention further relates to a processing apparatus, comprising:

at least one receiving device for receiving a planned trajectory of a first vehicle, which can be output by means of a mobile radio interface of the first vehicle, and for receiving a planned trajectory of a second vehicle, which can be output by means of a mobile radio interface of the second vehicle or a further infrastructure device,

a computing device which is configured to evaluate the planned trajectory of the first vehicle relative to the planned trajectory of the second vehicle with respect to a potential safety-critical situation,

an outputting device for outputting the planned trajectory of the second vehicle for the purpose of outputting by means of an outputting device suitable for communicating via a mobile radio network to be received by the first vehicle or the infrastructure device, if a potential safety-critical situation has been detected by means of the computing device.

According to a further development, the processing apparatus is configured to execute an embodiment of the method for execution by a processing apparatus.

The invention further relates to a communication apparatus of a first vehicle or an infrastructure device, comprising:

a mobile radio interface, designed to output a planned trajectory of the first vehicle, as well as

a communication interface for direct vehicle-to-X communication, designed to carry out the planned trajectory of the first vehicle substantially simultaneously or in parallel to the outputting by means of the mobile radio interface.

According to a further development, the communication apparatus is configured to execute an embodiment of the method for execution by a communication apparatus.

The invention further relates to a system, comprising:

an embodiment of the processing apparatus according to the invention, and

an embodiment of the communication apparatus according to the invention,

wherein the system is configured to execute an embodiment of the method for preventing a potential safety-critical traffic situation between a first vehicle and a second vehicle.

In at least one further development of the indicated apparatuses, the indicated apparatuses each have a respective memory and a processor. The respective indicated methods are stored in the form of computer programs in the respective memory and the respective processor is provided for executing the respective method when the respective computer program is loaded from the respective memory into the respective processor.

According to a further aspect of the invention, a computer program comprises program code means in order to perform all the steps of one of the indicated methods when the computer program is run on a computer or one of the indicated devices.

According to a further aspect of the invention, a computer program product contains program code which is saved on a computer-readable data carrier and which, when it is run on a data processing device, performs one of the indicated methods.

Some particularly advantageous configurations of the invention are indicated in the subclaims. Further preferred embodiments are also set out in the following description of exemplary embodiments with reference to FIG. 1.

### BRIEF DESCRIPTION OF THE DRAWINGS

FIG. 1 shows an embodiment of the method for preventing a potential safety-critical traffic situation between a first vehicle and a second vehicle according to the invention in the form of a flow chart.

### DETAILED DESCRIPTION

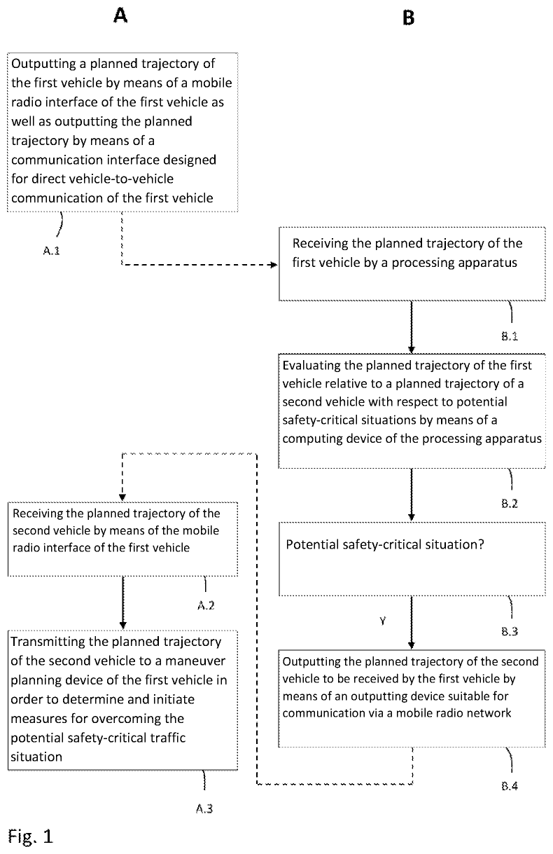

FIG. 1 shows an embodiment of the method for preventing a potential safety-critical traffic situation between a first vehicle and a second vehicle according to the invention in the form of a flow chart. Here, the method steps in accordance with an embodiment of the method for execution by a communication apparatus of a first vehicle according to the invention are depicted on the left side A of FIG. 1, and the method steps in accordance with an embodiment of the method for execution by a processing apparatus according to the invention are depicted on the right side B of FIG. 1. A separate representation of the method steps relative to the method for execution by a communication apparatus of a second vehicle has been dispensed with, since this would correspond to the method for execution by the communication device of the first vehicle relative to the exemplary embodiment shown here.

In accordance with a step A.1 of the method for execution by a communication apparatus of the first vehicle, a planned trajectory of the first vehicle is output by means of a mobile radio interface of the first vehicle and the planned trajectory is output in parallel by means of a communication interface designed for direct vehicle-to-X communication of the first vehicle.

In a step B.1 of the method for execution by the processing apparatus, the processing apparatus receives the planned trajectory of the first vehicle. Moreover, according to method steps which are not depicted separately, a planned trajectory of a second vehicle is output by means of a mobile radio interface of the second vehicle and the planned trajectory of the second vehicle is output by means of a communication interface designed for direct vehicle-to-X communication of the second vehicle, and the planned trajectory of the second vehicle is received by the processing apparatus. In a step B.2, the planned trajectory of the first vehicle relative to the planned trajectory of the second vehicle with respect to potential safety-critical situations is evaluated by means of a computing device of the processing apparatus. If, in a step B.3, a potential safety-critical situation is detected, which is depicted by means of Y in FIG. 1, the planned trajectory of the second vehicle is output, to be received by the first vehicle, in a step B.4 by means of an outputting device suitable for communicating via a mobile radio network. If no safety-critical situation is detected in step B.4, the trajectories can be checked or rejected, for example relative to a potential safety-critical situation of possible further received trajectories of further vehicles. Here, a message can also be provided to the first and/or the second vehicle to provide information that no potential safety-critical situation has been detected.

In a step A.2, the first vehicle receives the planned trajectory of the second vehicle by means of the mobile radio interface and, in a step A.3, the planned trajectory of the second vehicle is transmitted to a maneuver planning device of the first vehicle in order to determine and initiate measures for overcoming the potential safety-critical traffic situation.

If in the course of the proceedings it transpires that a feature or a group of features is not absolutely necessary, then the applicant here and now seeks a wording of at least one independent claim, no longer having the feature or the group of features. This may, for example, involve a sub-combination of a claim existing as at the application date or a sub-combination of a claim existing as at the application date restricted by further features. Such claims or combinations of features, which are to be newly worded, are understood to also be covered by the disclosure of this application.

It is further pointed out that configurations, features and variants of the invention, which are described in the various embodiments or exemplary embodiments and/or shown in the figures, can be combined with one another as desired. Individual or multiple features are interchangeable as desired. Resulting combinations of features are understood to also be covered by the disclosure of this application.

Back references in dependent claims should not be construed as a waiver of the right to independent, objective protection for the features of the subclaims referred back to. These features can also be used in any combination with other features.

Features which are solely disclosed in the description or features which are disclosed in the description or a claim only in conjunction with other features can, in principle, be of independent inventive relevance. They can therefore also be included separately in claims to distinguish from the prior art.

1. A method for execution by a processing apparatus, having the steps of:
receiving a planned trajectory of a first vehicle, which has been output by mobile radio interface of the first vehicle or an infrastructure device,
receiving a planned trajectory of a second vehicle, which has been output by mobile radio interface of the second vehicle or a further infrastructure device,
evaluating the planned trajectory of the first vehicle relative to the planned trajectory of the second vehicle with respect to a potential safety-critical situation by a computing device of the processing apparatus and, if a potential safety-critical situation is detected,
outputting the planned trajectory of the second vehicle for the purpose of outputting by an outputting device suitable for communicating via a mobile radio network, to be received by the mobile radio interface of the first vehicle or of the infrastructure device.

2. The method according to claim 1, wherein, in the event that a potential safety-critical situation has been detected, the planned trajectory of the second vehicle is not output, if the processing apparatus receives information from the first vehicle and/or the second vehicle announcing that a forwarding between the first vehicle and the second vehicle by the processing device is no longer required.

3. The method according to claim 2, furthermore having the step of:
receiving environmental information of the first vehicle or the infrastructure device, captured by sensors, which has been output by the mobile radio interface of the first vehicle or the infrastructure device.

4. The method according to claim 3, wherein a proposed trajectory and an alternative trajectory of the first vehicle as well as a proposed trajectory and an alternative trajectory of the second vehicle are received by the processing apparatus and wherein the proposed trajectory of the first vehicle relative to the proposed trajectory of the second vehicle is evaluated with respect to potential safety-critical situations by the computing device of the processing apparatus.

5. The method according to claim 4, wherein in the event that a potential safety-critical situation of the proposed trajectory of the first vehicle relative to the proposed trajectory of the second vehicle is detected, the proposed trajectory of the first vehicle relative to the alternative trajectory of the second vehicle and/or the alternative trajectory of the first vehicle relative to the proposed trajectory of the second vehicle and/or the alternative trajectory of the first vehicle relative to the alternative trajectory of the second vehicle with respect to potential safety-critical situations is/are evaluated by a computing device of the processing apparatus.

6. A method for execution by a communication apparatus of a first vehicle or an infrastructure device, having the steps of:
outputting a planned trajectory of the first vehicle by a mobile radio interface of the first vehicle or the infrastructure device to be received by a processing apparatus, as well as
outputting the planned trajectory by communication interface designed for direct vehicle-to-X communication of the first vehicle and/or the infrastructure device to be received by a second vehicle.

7. The method according to claim 6, furthermore having the steps of:
receiving a planned trajectory of a second vehicle by the processing device using the mobile radio interface,
transmitting the planned trajectory of the second vehicle to a maneuver planning device of the first vehicle in order to determine and initiate measures for overcoming the potential safety-critical traffic situation.

8. The method according to claim 7, furthermore having the steps of:
receiving a directly transmitted vehicle-to-X message from the second vehicle,
outputting, by the mobile radio interface, to be received by the processing apparatus, information announcing that a forwarding between the first vehicle and the second vehicle or the infrastructure device and the second vehicle by the processing device is no longer required.

9. The method according to claim 8, furthermore having the steps of:
outputting environmental information of the first vehicle or the infrastructure device, captured by sensors, by the mobile radio interface of the first vehicle, as well as
outputting the environmental information captured by sensors by the communication interface designed for direct vehicle-to-X communication of the first vehicle and/or the infrastructure device.

10. The method according to claim 9, wherein a collective perception message comprises the environmental information output by the communication interface designed for direct vehicle-to-X communication of the first vehicle or the infrastructure device.

11. The method according to claim 10, wherein at least one proposed trajectory and at least one alternative trajectory are in each case output by the mobile radio interface of the first vehicle or the infrastructure device as well as by the communication interface designed for direct vehicle-to-X communication of the first vehicle or the infrastructure device.

12. A method for preventing a potential safety-critical traffic situation between a first vehicle and a second vehicle, having the steps of:
outputting a planned trajectory of the first vehicle by a mobile radio interface of the first vehicle or an infrastructure device to be received by a processing apparatus as well as outputting the planned trajectory by a communication interface designed for direct vehicle-to-X communication of the first vehicle or the infrastructure device,
receiving the planned trajectory of the first vehicle by the processing apparatus,
evaluating the planned trajectory of the first vehicle relative to a received planned trajectory of the second vehicle with respect to a potential safety-critical situation by a computing device of the processing apparatus and, if a potential safety-critical situation is detected,
outputting the planned trajectory of the second vehicle to be received by the first vehicle or the infrastructure device by an outputting device suitable for communicating via a mobile radio network,
receiving the planned trajectory of the second vehicle by the mobile radio interface of the first vehicle or the infrastructure device, and
transmitting the planned trajectory of the second vehicle to a maneuver planning device of the first vehicle in order to determine and initiate measures for overcoming the potential safety-critical traffic situation.

13. A processing apparatus, comprising:
at least one receiving device for receiving a planned trajectory of a first vehicle, which can be output by a mobile radio interface of the first vehicle or an infrastructure device, and for receiving a planned trajectory of a second vehicle, which can be output by a mobile radio interface of the second vehicle or a further infrastructure device,
a computing device which is configured to evaluate the planned trajectory of the first vehicle relative to the planned trajectory of the second vehicle with respect to a potential safety-critical situation,
an outputting device for outputting the planned trajectory of the second vehicle for the purpose of outputting by an outputting device suitable for communicating via a mobile radio network to be received by the first vehicle or the infrastructure device, if a potential safety-critical situation has been detected by the computing device.

14. The processing apparatus according to claim 13, configured to perform operations comprising:
receiving a planned trajectory of a first vehicle, which has been output by a mobile radio interface of the first vehicle or an infrastructure device,
receiving a planned trajectory of a second vehicle, which has been output by a mobile radio interface of the second vehicle or a further infrastructure device,
evaluating the planned trajectory of the first vehicle relative to the planned trajectory of the second vehicle with respect to a potential safety-critical situation by a computing device of the processing apparatus and, if a potential safety-critical situation is detected,
outputting the planned trajectory of the second vehicle for the purpose of outputting by an outputting device suitable for communicating via a mobile radio network, to be received by the mobile radio interface of the first vehicle or of the infrastructure device;
wherein, in the event that a potential safety-critical situation has been detected, the planned trajectory of the second vehicle is not output, if the processing apparatus receives information from the first vehicle and/or the second vehicle announcing that a forwarding between the first vehicle and the second vehicle by the processing device is no longer required;
receiving environmental information of the first vehicle or the infrastructure device, captured by sensors, which has been output by the mobile radio interface of the first vehicle or the infrastructure device;
wherein a proposed trajectory and an alternative trajectory of the first vehicle as well as a proposed trajectory and an alternative trajectory of the second vehicle are receded by the processing apparatus and wherein the proposed trajectory of the first vehicle relative to the proposed trajectory of the second vehicle is evaluated with respect, to potential safety-critical situations by the computing device of the processing apparatus; and
wherein in the event that a potential safety-critical situation of the proposed trajectory of the first vehicle relative to the proposed trajectory of the second vehicle is detected, the proposed trajectory of the first vehicle relative to the alternative trajectory of the second vehicle and/or the alternative trajectory of the first vehicle relative to the proposed trajectory of the second vehicle and/or the alternative trajectory of the first vehicle relative to the alternative trajectory of the second vehicle with respect to potential safety-critical situations is/arc evaluated by a computing device of the processing apparatus.

15. A communication apparatus of a first vehicle or an infrastructure device, comprising:
a mobile radio interface, designed to output a planned trajectory of the first vehicle, as well as
a communication interface for direct vehicle-to-X communication, designed to carry out the planned trajectory of the first vehicle substantially simultaneously to the outputting by the mobile radio interface.

16. A communication apparatus according to claim 15, configured to perform operations comprising:
outputting a planned trajectory of the first vehicle by a mobile radio interface of the first vehicle or the infrastructure device to be received by a processing apparatus;
outputting the planned trajectory by a communication interface designed for direct vehicle-to-X communication of the first vehicle and/or the infrastructure device to be received by a second vehicle;
receiving a planned trajectory of a second vehicle by the processing device using tee mobile radio interface,
transmitting the planned trajectory of the second vehicle to a maneuver planning device of the first vehicle in order to determine and initiate measures for overcoming the potential safety-critical traffic situation;
receiving a directly transmitted vehicle-to-X message from the second vehicle;
outputting, by the mobile radio interface, to be received by the processing apparatus, information announcing that a forwarding between the first vehicle and the second vehicle or the infrastructure device and the second vehicle by the processing device is no longer reunited;
outputting environmental information of the first vehicle or the infrastructure device, captured by sensors, by the mobile radio interface of the first vehicle;
outputting the environmental information captured by sensors by the communication Interface designed for direct vehicle-to-X communication of the first vehicle and/or the infrastructure device;
wherein a collective perception message comprises the environmental information output by the communication interface designed for direct vehicle-to-X communication of the first vehicle or the infrastructure device; and
wherein at least one proposed trajectory and at least one alternative trajectory are in each case output by the mobile radio interface of the first vehicle or the infrastructure device as well as by the communication interface designed for direct vehicle-to-X communication of the first vehicle or the infrastructure device.

17. A system, comprising:
a processing apparatus comprising:
at least one receiving device for receiving a planned trajectory of a first vehicle, which can be output by a mobile radio interface of the first vehicle or an infrastructure device, and for receiving a planned trajectory of a second vehicle, which can be output by a mobile radio interface of the second vehicle or a further infrastructure device,
a computing device which is configured to evaluate the planned trajectory of the first vehicle relative to the planned trajectory of the second vehicle with respect to a potential safety-critical situation,
an outputting device for outputting the planned trajectory of the second vehicle for the purpose of outputting by an outputting device suitable for communicating via a mobile radio network to be received by the first vehicle or the infrastructure device, if a potential safety-critical situation has been detected by the computing device,
wherein the processing apparatus is configured to perform operations comprising:
receiving a planned trajectory of a first vehicle, which has been output by a mobile radio interface of the first vehicle or an infrastructure device,
receiving a planned trajectory of a second vehicle, which has been output by a mobile radio interface of the second vehicle or a further infrastructure device,
evaluation the planned trajectory of the first vehicle relative to the planned trajectory of the second vehicle with respect to a potential safety-critical situation by a computing device of the processing apparatus and, if a potential safety-critical situation is detected,
outputting the planned trajectory of the second vehicle for the purpose of outputting by an outputting device suitable for communicating via a mobile radio network, to be received by the mobile radio interface of the first vehicle or of the infrastructure device;
wherein, in the event that a potential safety-critical situation has been detected, the planned trajectory of the second vehicle is not output, if the processing apparatus receives information from the first vehicle and/or the second vehicle announcing that a forwarding between the first vehicle and the second vehicle by the procession device is no longer required;
receiving environmental information of the first vehicle or the infrastructure device, captured by sensors, which has been output by the mobile radio interface of the first vehicle or the infrastructure device;
wherein a proposed trajectory and an alternative trajectory of the first vehicle as well as a proposed trajectory and an alternative trajectory of the second vehicle are received by the processing apparatus and wherein the proposed trajectory of the first vehicle relative to the proposed trajectory of she second vehicle is evaluated with respect to potential safety-critical situations by the computing device of the processing apparatus; and
wherein in the event that a potential safety-critical situation of the proposed trajectory of the first vehicle relative to the proposed trajectory of the second vehicle is detected, the proposed trajectory of the first vehicle relative to the alternative trajectory of the second vehicle and/or the alternative trajectory of the first vehicle relative to the proposed trajectory of the second vehicle and/or the alternative trajectory of she first vehicle relative to the alternative trajectory of the second vehicle with respect to potential safety-critical situations is/are evaluated by a computing device of the processing apparatus, and
a communication apparatus, of a first vehicle or an infrastructure device, comprising:
a mobile radio interface, designed to output a planned trajectory of the first vehicle,
a communication interface for direct vehicle-to-X communication, designed to carry out the planned trajectory of the first vehicle substantially simultaneously to the outputting by the mobile radio interface,
wherein the communication apparatus is configure to perform operations comprising:
outputting a claimed trajectory of the first vehicle by a mobile radio interface of the first vehicle or the infrastructure device to be received by a processing apparatus;
outputting the planned trajectory by a communication interface designed for direct vehicle-to-X communication of the first vehicle and/or the infrastructure device to be received by a second vehicle;
receiving a planned trajectory of a second vehicle by the processing device using the mobile radio interface,
transmitting the planned trajectory of the second vehicle to a maneuver planning device of the first vehicle in order to determine and initiate measures for overcoming the potential safety-critical traffic situation;
receiving a directly transmitted vehicle-to-X message from the second vehicle;
outputting, by the mobile radio interface, to be received by the processing apparatus, information announcing that a forwarding between the first vehicle and the second vehicle or the infrastructure device and the second vehicle by the processing device is no longer required;
outputting environmental information of the first vehicle or the infrastructure device captured by sensors, by the mobile radio interface of the first vehicle;
outputting the environmental information captured by sensors by the communication interface designed for direct vehicle-in-X communication of the first vehicle and/or the infrastructure device;
wherein a collective perception message comprises the environmental information output by the communication interface designed for direct vehicle-to-X communication of the first vehicle or the infrastructure device; and
wherein at least one proposed trajectory and at least one alternative trajectory are in each case output by the mobile radio interface of the first vehicle or the infrastructure device as well as by the communication interface designed for direct vehicle-to-X communication of the first vehicle or the infrastructure device; and
wherein the system is configured to perform operations comprising:
outputting a planned trajectory of the first vehicle by a mobile radio interface of the first vehicle or an infrastructure device to be received by a processing apparatus as well as outputting the planned trajectory by a communication interface designed for direct vehicle-to-X communication of the first vehicle or the infrastructure device,
receiving the planned trajectory of the first vehicle by the processing apparatus,
evaluating the planned trajectory of the first vehicle relative to a received planned trajectory of the second vehicle with respect to a potential safety-critical situation by a computing device of the processing apparatus and, if a potential safety-critical situation is detected,
outputting the planned trajectory of the second vehicle to be received by the first vehicle or the infrastructure device by an outputting device suitable for communicating via a mobile radio network,
receiving the planned trajectory of the second vehicle by the mobile radio interface of the first vehicle or the infrastructure device, and
transmitting the planned trajectory of the second vehicle to a maneuver planning device of the first vehicle in order to determine and initiate measures for overcoming the potential safety-critical traffic situation.
